(19) United States
(12) Patent Application Publication
(10) Pub. No.: US 2024/0417280 A1
(43) Pub. Date: Dec. 19, 2024

(54) WATER TREATMENT EQUIPMENT

(71) Applicant: P & I Human Korea Co., Ltd., Seoul (KR)

(72) Inventor: Bong Chang Hong, Gyeonggi-do (KR)

(21) Appl. No.: 18/704,307

(22) PCT Filed: Jul. 22, 2022
(86) PCT No.: PCT/KR2022/010764

§ 371 Date: Apr. 24, 2024

(30) Foreign Application Priority Data
Dec. 31, 2021 (KR) 10-2021-0193917

(51) Int. Cl. C02F 1/00

(52) U.S. Cl. CPC C02F 1/004; C02F 2201/002; C02F 2303/06

(57) ABSTRACT

The present invention relates to water treatment equipment for allowing contaminated water, having flowed into the center of a filtration tank, to radially pass therethrough, thereby filtering same, the water treatment equipment comprising: a guide part for guiding contaminated water to the inner center of the filtration tank; a tubular filter part arranged on the guide part; a discharge pipe part for discharging, during washing, pollutants such as sludge, which are stripped from the tubular filter part, and washing water to the outside of the system; and a filter washing part for spraying, at the tubular filter part, washing water for backwash.

### TECHNICAL FIELD

The present disclosure relates to water treatment equipment and, particularly, relates to water treatment equipment configured to discharge pollutants such as sludge stripped and washing water to the outside of the system during washing.

### BACKGROUND ART

Various pollutants occurring around us may be divided into point source pollutants and non-point source pollutants. Point source pollutants are pollutants emitted from so-called point sources with a clear and limited point of origin, such as domestic sewage or industrial wastewater generated from ordinary homes or factories. In addition, non-point source pollutants are pollutants that occur in a wide area without a defined contaminated area, such as farmland, pastureland, forestry, or roads.

Non-point source pollutants include, for example, fertilizers or pesticides sprayed on farmland, livestock runoff, dust, heavy metals, pathogenic microorganisms, organic compounds, and radioactive materials, and remain as dust and waste, etc., and when it rains, are washed by initial rainwater and flow into surrounding rivers or groundwater. Accordingly, it is very important to block initial rainwater from flowing directly into rivers or groundwater.

Accordingly, various types of non-point source pollution reduction facilities are applied to recently built new cities, residential areas, or highly polluted areas to prevent environmental pollution by non-point source pollutants. This non-point source pollution reduction facility is a type of water treatment equipment through which initial rainwater having non-point source pollutants and untreated sewage overflow water (CSOs, SSOs) during rainfall pass, whereby pollutants in the rainwater are filtered out, and the rainwater is purified to some extent and is sent out.

Meanwhile, in order to maintain the best performance of water treatment equipment for treating untreated sewage overflows (CSOs, SSOs) during initial rain and rainfall, various contaminants filtered by built-in screen filters or filter media, such as captured sludge, impurities, or sediment, are required to be frequently removed to ensure that the filters or filter media function as originally designed.

Patent Document 1, which proposes a method for cleaning filters or filter media inside water treatment equipment, discloses the arrangement of multiple nozzles around a curtain screen to clean the curtain screen.

As mentioned above, according to Patent Document 1, contaminants deposited or attached to the curtain screen can be removed by hitting washing water sprayed from the nozzles against the curtain screen, but there is limitation in discharging contaminants such as sludge stripped from a filtration element disposed within the curtain screen, and washing water to the outside. When these contaminants and washing water remain within the curtain screen, there are problems such as causing water pollution and bad odor.

### DOCUMENT OF RELATED ART

### Patent Document

(Patent Document 1) Korean Patent No. 10-0823236

### DISCLOSURE

### Technical Problem

The present disclosure has been made to solve the problems described above, and is intended to propose water treatment equipment which can remove contaminants from contaminated water by means of a tubular filter part having filter media disposed therein.

Particularly, the water treatment equipment of the present disclosure is configured to discharge contaminants such as stripped sludge and washing water to the outside when washing the tubular filter part to maintain ability to remove contaminants.

### Technical Solution

In order to accomplish the above objectives, water treatment equipment according to an exemplary embodiment of the present disclosure includes:
a guide part having a conical body open up and down, an inflow pipe extending downward from the conical body to guide contaminated water into a filtration tank, and an annular support surface having multiple discharge holes disposed to be spaced apart in a circumferential direction from each other and a hinged cover configured to open and close each of the discharge holes, with the annular support surface being disposed along an upper edge of the conical body;
a tubular filter part having a fixed frame configured to dispose multiple compartments divided along an inner circumferential edge of the annular support surface and a curtain filtration layer inserted into each of the compartments, with the tubular filter part installed in a tubular shape on the annular support surface;
a discharge pipe part having multiple buoyancy tubes disposed respectively under the discharge holes of the annular support surface to enable fluid communication therebetween, and a duct being in fluid communication with the multiple buoyancy tubes and extending to the outside of the filtration tank; and
a filter washing part configured to spray washing water for backwashing on the tubular filter part,
wherein the tubular filter part allows contaminated water guided into the guide part) to pass through the tubular filter part in a radial direction for filtration, and during backwashing, contaminants stripped from filter media of the tubular filter part and washing water are discharged through the discharge pipe part to the outside of the filtration tank.

In the embodiment of the present disclosure, the discharge hole may be located in an inner area of a lower end of the compartment.

Preferably, the discharge pipe part may include: the multiple buoyancy tubes having upper through-holes and lower through-holes; a buoyancy ball configured to open and close the hinged cover by moving up and down according to a water level inside each of the buoyancy tubes; and the duct disposed to be in fluid communication with lower parts of the multiple buoyancy tubes, with the duct having a valve provided on an end part of a pipe thereof.

In addition, the water equipment treatment of the present disclosure may further include a branch pipe extending to the outside of the filtration tank by branching off from the inflow pipe, and a valve provided on an end part of the branch pipe.

In addition, the water equipment treatment of the present disclosure may further include one or more fine mesh filter parts having concentric structures with the tubular filter part and disposed on the annular support surface.

Selectively, the fixed frame may define the multiple compartments through a perforated screen having a tubular shape disposed on an inner circumferential edge of the annular support surface along a circumference thereof, a tubular fixed mesh disposed outside the perforated screen on the annular support surface, with the tubular fixed mesh being concentric with the perforated screen and having an increased diameter, and multiple partition walls disposed to be spaced apart from each other in a circumferential direction between the perforated screen having a tubular shape and the tubular fixed mesh.

Preferably, the curtain filtration layer may be provided with one or more fibrous filter media.

In addition, according to the present disclosure, the one or more fibrous filter media of the curtain filtration layer and the one or more fine mesh filter parts may be formed and arranged to be denser gradually in a radial direction.

The features and advantages of the present disclosure will become more apparent from the following detailed description based on the accompanying drawings.

Prior to this, terms or words used in this specification and claims should not be interpreted in their usual, dictionary meanings, and based on the principle that the inventor can appropriately define the concepts of the terms in order to explain his or her invention in the best way, the terms must be interpreted with meanings and concepts consistent with the technical idea of the present disclosure.

### Advantageous Effects

According to the description of the present disclosure above, the water treatment equipment of the present disclosure is provided to effectively filter contaminated water flowing into the filtration tank by passing the contaminated water through the tubular filter part in a radial direction, and to discharge sludge stripped from fibrous filter media of the tubular filter part and washing water out of the filtration tank.

In addition, in the water treatment equipment of the present disclosure, the tubular filter part is designed to be formed in a radial shape so as to minimize an installation area thereof and improve the treatment efficiency of contaminants within a limited space.

Particularly, the water treatment equipment of the present disclosure can economically operate the filtration and backwash functions without a separate power source, thereby reducing consumption of electricity produced by burning fossil fuels and securing certified emission reduction (CER) equivalent to reduced carbon dioxide emissions corresponding to the reduced electricity consumption.

### DESCRIPTION OF DRAWINGS

FIG. 1 is a partial cutaway diagram schematically illustrating water treatment equipment according to an exemplary embodiment of the present disclosure.

FIG. 2 is a vertical sectional view schematically illustrating the water treatment equipment according to the exemplary embodiment of the present disclosure.

FIG. 3 is an exploded perspective view schematically illustrating an important part of the water treatment equipment according to the exemplary embodiment of the present disclosure.

FIG. 4 is a partial cutaway diagram schematically illustrating a discharge pipe part illustrated in FIG. 3.

FIG. 5 is a schematic diagram schematically illustrating the operating process of the water treatment equipment according to the exemplary embodiment of the present disclosure.

### BEST MODE

The purpose, specific advantages and novel features of the present disclosure will become more apparent from the following detailed description and examples taken in conjunction with the accompanying drawings. In this specification, when adding reference numerals to components in each drawing, it should be noted that identical components are given the same number as much as possible even if they are shown in different drawings. In addition, when explaining the present disclosure, if it is judged that a detailed description of the related known technology may unnecessarily obscure the gist of the present disclosure, the detailed description thereof is omitted. In this specification, terms such as first and second are used to distinguish one component from another component, but the components are not limited by the terms. In the accompanying drawings, some components are exaggerated, omitted, or schematically illustrated, and the size of each component does not entirely reflect the actual size.

Water treatment equipment according to the present disclosure is, for example, installed in a non-point source pollution area and functions to effectively filter and remove non-point source pollutants such as impurities, silt, solids, floating substances, suspended substances, and various wastes flowing in from non-point pollution sources by being mixed with rainwater during initial rainfall, and the size and shape of the water treatment equipment may vary depending on the processing capacity of the water treatment equipment.

In addition, the water treatment equipment of the present disclosure is configured to discharge, during backwashing, contaminants such as sludge stripped from filter media, preferably, fibrous filter media disposed in a tubular filter part of the water treatment equipment and washing water to the outside of the water treatment equipment.

Hereinafter, the water treatment equipment according to the present disclosure will be described in more detail with reference to the accompanying drawings.

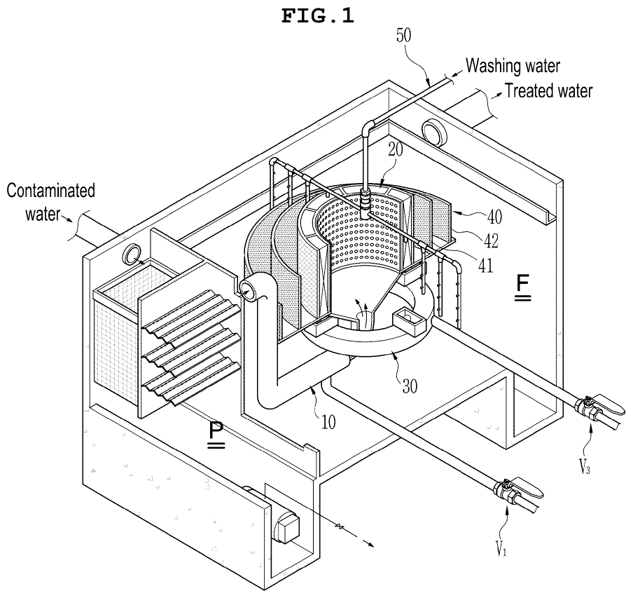

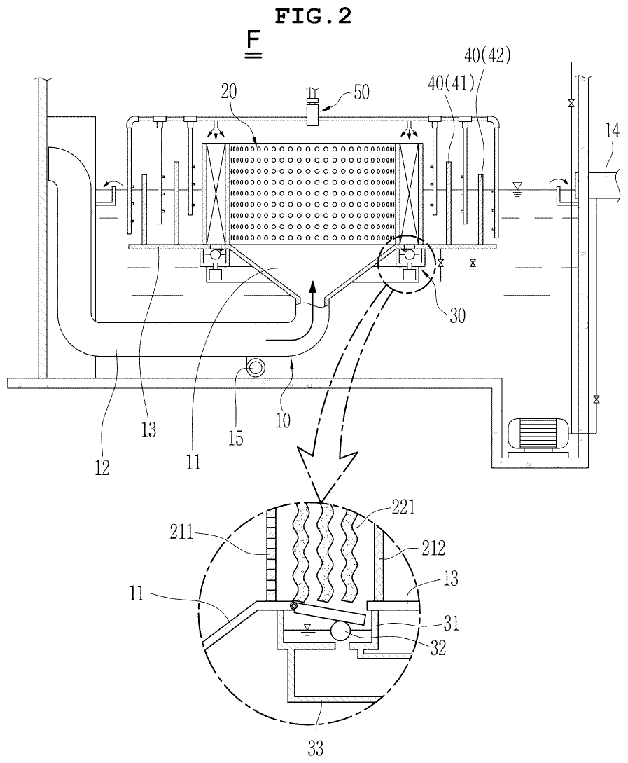

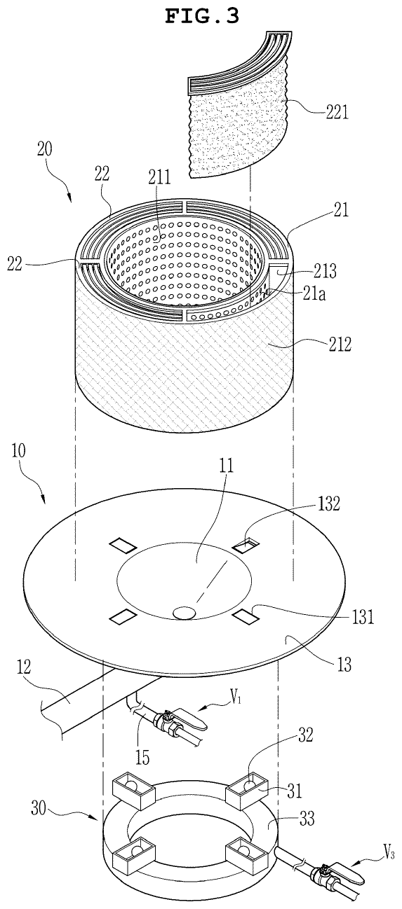

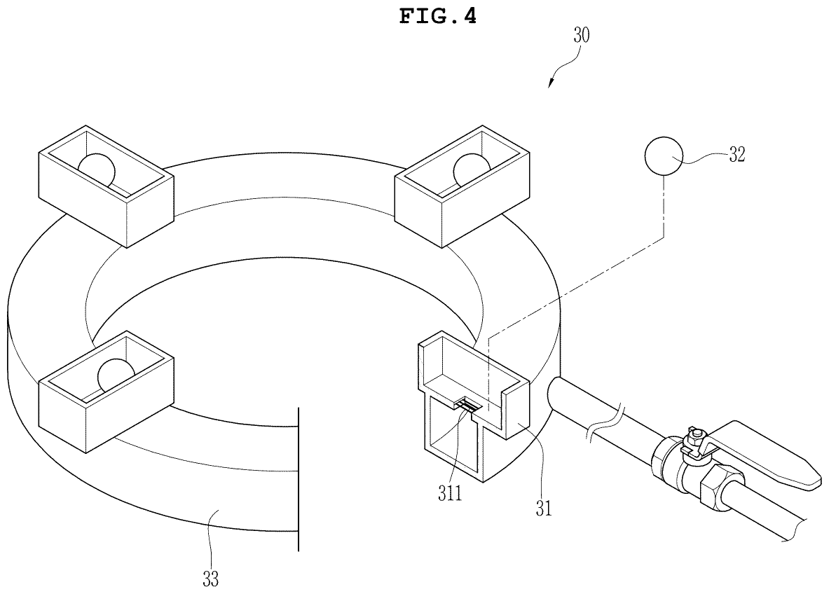

Referring to FIGS. 1 to 4, the water treatment equipment according to the exemplary embodiment of the present disclosure is configured to filter and discharge contaminated water flowing into a filtration tank F.

In addition, in the water treatment equipment of the present disclosure, a pretreatment tank P may be disposed at an upstream part of the filtration tank F. The pretreatment tank P may guide contaminated water, for example, contaminated water that has filtered out contaminants of a certain size or larger contained in rainwater through an inflow pipe 12 to the filtration tank F. As known to those skilled in the art, the pretreatment tank may be equipped with any combination of a coarse screen, a fine screen, and a perforated screen to filter out cigarette butts, leaves, or other general waste contained in rainwater. The perforated screen may be a corrugated plate member with multiple through holes drilled therein.

The water treatment equipment of the present disclosure includes a guide part 10 that directs contaminated water from a non-point pollution source or the pretreatment tank P into the filtration tank F, a tubular filter part 20 disposed on the guide part 10, and a discharge pipe part 30 that discharges, during washing, contaminants such as sludge stripped from the tubular filter part and washing water to the outside of the system.

In addition, the water treatment equipment of the present disclosure includes one or more fine mesh filter parts 40 disposed on the guide part 10 by having structures concentric to the tubular filter part 20.

As described above, the guide part 10 is a component configured to guide contaminated water from a non-point pollution source or the pretreatment tank into the filtration tank F and support the tubular filter part and the one or more fine mesh filter parts, and includes a conical body 11 having a shape open up and down and having a wide upper side and a narrow lower side, the inflow pipe 12 extending in a tubular shape from the open lower part of the conical body, and an annular support surface 13 disposed around the upper edge of the conical body.

As illustrated in the drawings, since the conical body 11 is open up and down inside and is formed in a funnel shape having an inner diameter decreasing gradually toward a lower side thereof from an upper side thereof, contaminated water flowing in through the inflow pipe 12 can be filtered while the contaminated water is gradually filled up inside the conical body and passes through the tubular filter part at a slow flow rate.

As mentioned above, the inflow pipe 12 guides contaminated water of a non-point pollution source or primarily treated contaminated water in the pretreatment tank P to the inside of the filtration tank F, specifically, to an inner hollow part surrounded by the conical body 11 and the tubular filter part 20.

The annular support surface 13 is fixed to the upper edge of the conical body 11 and may support the tubular filter part 20 and the one or more fine mesh filter parts 40. Furthermore, the annular support surface 13 is provided with multiple discharge holes 131 disposed in a circumferential direction to be adjacent to an inner circumferential edge thereof, and a hinged cover 132 configured to open and close each of the discharge holes 131. In the embodiment of the present disclosure, the hinged cover 132 may be hinged to the discharge hole 131 to open and close the discharge hole. As illustrated in the drawing, the multiple discharge holes 131 may be disposed to be spaced apart from each other at equal intervals along the circumference of the annular support surface 13, and the length of the discharge hole has a size to cross radially the inner area of a compartment between the perforated screen 211 and a fixed mesh 212.

Preferably, the hinged cover 132 is hinged to the lower surface of the annular support surface and is installed to be rotatable downward. In addition, to prevent water from leaking through a gap between the discharge hole and the hinged cover when the hinged cover is closed, the guide part 10 may include a sealing member (not shown) provided along the lower edge of the discharge hole 131. Since the coupling method of the hinged cover is already widely known, detailed descriptions and drawings of the hinge coupling are excluded from this specification.

The tubular filter part 20 is disposed on the inner circumferential edge of the annular support surface 13 by being adjacent thereto along a circumference thereof, and is installed on the support surface by having a predetermined thickness and a tubular shape. As illustrated in the drawing, the tubular filter part may be formed in a shape of a cylinder with a predetermined thickness so that contaminated water guided into the inflow pipe 12 can be filtered while passing through the tubular filter part in a radial direction, but is not limited thereto, and may be formed as a hollow structure with a closed cross-section, such as a shape of a square container.

Specifically, the tubular filter part 20 is composed of a fixed frame 21 configured to have multiple compartments 21a divided, and a curtain filtration layer 22 inserted into each of the compartments 21a.

The fixed frame 21 includes the perforated screen 211 having a tubular shape disposed on the inner circumferential edge of the annular support surface by being adjacent thereto along a circumference thereof, the tubular fixed mesh 212 disposed in a circumferential direction on the annular support surface, with the tubular fixed mesh having a different diameter from the perforated screen 211 and being concentric therewith, and multiple partition walls 213 dividing space between the perforated screen 211 having a tubular shape and the tubular fixed mesh 212. In other words, in the tubular filter part, the tubular fixed mesh 212 is formed to have a larger diameter than the perforated screen 211 having a tubular shape, thereby securing the space between the fixed mesh and the perforated screen to give the fixed frame 21 a predetermined thickness.

In addition, in the fixed frame 21, to evenly divide the space between the perforated screen and the fixed mesh in a circumferential direction, the multiple partition walls 213 are disposed to be spaced apart at equal intervals from each other between the perforated screen and the fixed mesh. The partition walls 213 are radially placed between the perforated screen 211 and the fixed mesh 212. Accordingly, each of the compartments 21a is defined by the annular support surface 13, the perforated screen 211, the fixed mesh 212, and the partition walls 213 and has a size and shape to accommodate the curtain filtration layer 22.

As a result, the fixed frame 21 can ensure a radial flow of contaminated water or a centripetal flow of washing water by the perforated screen 211 and the fixed mesh 212, and may have an open upper surface to allow the moving of the curtain filtration layer 22 into or out of each of the compartments.

In the embodiment of the present disclosure, the discharge hole 131 of the annular support surface 13 is preferably located in the lower inner area of each of the compartments 21a. In other words, the discharge hole 131 is located at the annular support surface surrounded by the fixed mesh 212, the perforated screen 211, and two partition walls 213 disposed to be adjacent to each other.

As described above, the curtain filtration layer 22 is formed in a size and shape to be received in the compartment 21a and has one or more fibrous filter media 221 disposed therein.

As is widely known, the fibrous filter media, which are filter media made of fibers, can effectively filter out microscopic contaminants (fine contaminants) contained in contaminated water.

Selectively, the one or more fibrous filter media 221 may be replaceably installed on a lid 22a of the curtain filtration layer 22. The one or more fibrous filter media 221 are arranged by being stacked in a radial direction. That is, the fibrous filter media may be arranged by being stacked to be spaced apart from each other in the radial direction. In addition, the one or more fibrous filter media 221 extend downward so that lower end parts thereof can be in close contact with the annular support surface (including the hinged cover). When the lower end parts of the fibrous filter media are not in close contact with the annular support surface and are spaced apart therefrom, contaminated water escapes through gaps between the filter media and the annular support surface without passing through the fibrous filter media, so a reliable effect cannot be expected. For reference, the fibrous filter media 221 of the curtain filtration layer 22 may have multiple layers of low-density fibrous filter media, medium-density fibrous filter media, and high-density fibrous filter media spaced apart from each other from the inside to the outside. Although three fibrous filter media are used in the drawing, this is not limiting, and two or at least four fibrous media may be stacked for filtration efficiency.

In addition, the water treatment equipment of the present disclosure may include the one or more fine mesh filter parts 40 having increased diameters while forming concentric circles on the outside of the tubular filter part 20. The one or more fine mesh filter parts 40; 41, 42 are arranged on the outside of the tubular filter part 20 by being stacked in a radial direction. For example, a first fine mesh filter part 41 is disposed on the outside of the tubular filter part 20, and a second fine mesh filter part 42 is disposed on the outside of the first fine mesh filter part 41.

In addition, according to the present disclosure, the tubular filter part 20, the first fine mesh filter part 41, and the second fine mesh filter part 42 have different heights. The first fine mesh filter part 41 is designed to be lower than the height of the tubular filter part 20, and correspondingly, the second fine mesh filter unit 42 is designed to be lower than the height of the first fine mesh filter unit 41. This is because when each of the filter parts are blocked, some of contaminated water flowing into the guide part 10 may overflow the first fine mesh filter part 41 and naturally fall into space between the first fine mesh filter part and the second fine mesh filter part, and correspondingly, some of contaminated water overflowing the first fine mesh filter part may overflow the second fine mesh filter part 42 and be transferred into the filtration tank F.

The one or more fine mesh filter parts are mesh plates with fine meshes of different sizes, and the first fine mesh filter part 41 is a plate-shaped filter member with a smaller mesh size than the tubular filter part 20. The first fine mesh filter part filters out contaminants that pass through the tubular filter part and allows water to pass through the first fine mesh filter part. Contaminants that pass through the first fine mesh filter part 41 are caught in the second fine mesh filter part 42 and removed. The second fine mesh filter part 42 has a denser structure than the first fine mesh filter part 41 and ultimately filters out contaminants. In summary, according to the present disclosure, the one or more fibrous filter media 221 inside the curtain filtration layer and the one or more fine mesh filter parts 40; 41, 42 may be arranged to be finer (denser) gradually in a radial direction.

Treated water passing through fine mesh filter part 42, which is clean water in which contaminants have been treated below an allowable level, flows out in a radial direction through the tubular filter part and the one or more fine mesh filter parts from the center of the filtration tank F, is filled inside the filtration tank F, overflows a drainage weir, and is drained through an outflow pipe 14.

Selectively, according to the present disclosure, a cylindrical screen (not shown) may be additionally provided inside the tubular filter part.

In addition, the water treatment equipment of the present disclosure may include a filter washing part 50 that performs a backwash function to maintain the contaminant removal ability of the tubular filter part 20 and the one or more fine mesh filter parts 40. The filter washing part 50 may be formed as a backwashing facility that implements a backwashing function through spraying washing water like a filter washing device disclosed in Korean Patent No. 10-1400313 registered by being filed on Jul. 15, 2013, and contents thereof are incorporated in this specification by reference. The present disclosure is not limited thereto, and may include any backwashing facility capable of backwashing the tubular filter part and the one or more fine mesh filter parts.

The water treatment equipment according to the exemplary embodiment of the present disclosure may perform backwashing by spraying washing water while rotating the filter washing part 50 around the tubular filter part 20, and includes the discharge pipe part 30 which can discharge sludge attached to the perforated screen 211, the fixed mesh 212, and the fibrous filter media 221 of the tubular filter part 20 and washing water in the process of the backwashing to the outside of the water treatment equipment, that is, the system.

The discharge pipe part 30 includes the multiple buoyancy tubes 31 disposed under the annular support surface 13 to enable fluid communication, a buoyancy ball 32 configured to open and close the hinged cover 132 by moving up and down in each of the buoyancy tubes 31, and a duct 33 in fluid communication with the multiple buoyancy tubes 31. Preferably, the duct 33 is in fluid communication with the multiple buoyancy tubes 31 and extends to the outside of the filtration tank F. In addition, the duct 33 is provided with a valve V₃ at an end part of the duct extending to the outside of the filtration tank F.

As illustrated in the drawing, the buoyancy tubes 31 are disposed between the annular support surface 13 and the duct 33 to enable fluid communication between the tubular filter part 20 supported on the annular support surface 13 and the duct 33. To this end, the buoyancy tube 31 is formed as a chamber structure open up and down. That is, the upper through-hole (not shown) of the buoyancy tube 31 is located on the lower surface of the annular support surface 13 corresponding to the discharge hole 131, and the lower through-hole (not shown) of the buoyancy tube is aligned with a through hole formed in the upper surface of the duct 33.

As described above, the buoyancy tube 31 has the spherical buoyancy ball 32 provided therein, with the buoyancy ball 32 being formed in size and shape to move up and down according to a water level. The buoyancy ball 32 may be made of stainless steel with chemical resistance and corrosion resistance.

In addition, the buoyancy ball 32 of the buoyancy tube 31 is prevented from closing the lower through-hole of the buoyancy tube 31. For example, the lower through-hole is formed as a square-shaped through-hole and has a width smaller than the outer diameter of the buoyancy ball to prevent the buoyancy ball from escaping downward. Accordingly, even when a water level inside the buoyancy tube 31 is lowered and the buoyancy ball 32 moves downward, the spherical surface of the buoyancy ball 32 does not completely cover the boundary of the lower through-hole and can ensure the movement of water through a gap between the buoyancy ball and the lower through-hole. The buoyancy tube 31 may selectively have a catching net 311 disposed in the lower through-hole so as to prevent the buoyancy ball 32 from seating in the lower through-hole.

As described above, the duct 33 is arranged in a ring shape to be in fluid communication with the multiple buoyancy tubes 31 located respectively under the multiple discharge holes 131 formed in a circumferential direction to be adjacent to the inner circumferential edge of the annular support surface 13, and the valve V₃ is installed on the end part of a pipe extending from one surface of the duct 33.

Selectively, in the water treatment equipment of the present disclosure, a valve V₁ is installed on an end part of a branch pipe 15 extending to the outside of the filtration tank F by branching off from the inflow pipe 12. When during backwashing, some of washing water along with contaminants such as sludge stripped from the tubular filter part 20 is introduced through the tubular filter part into the conical body 11 of the guide part 10, some of the washing water along with the contaminants may be discharged to the outside by opening the valve V₁ of the branch pipe.

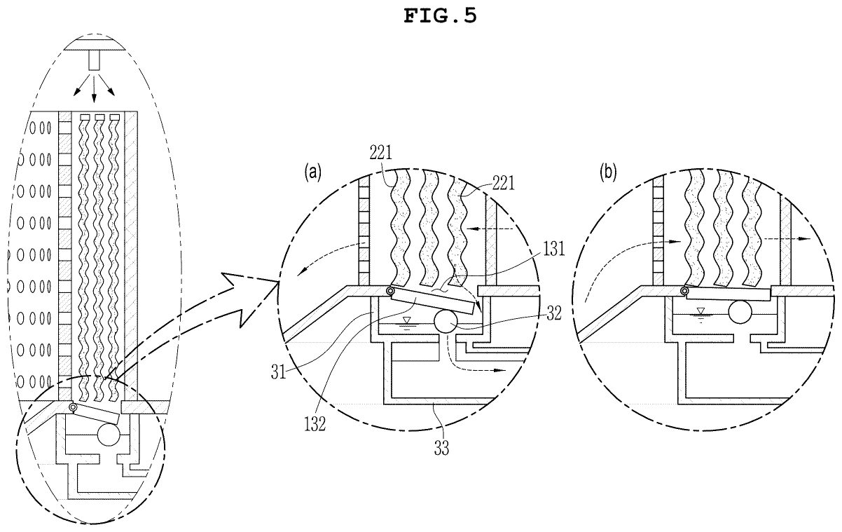

FIG. 5 is a schematic diagram schematically illustrating the operating process of the water treatment equipment according to the exemplary embodiment of the present disclosure.

As described above, during a backwashing process, the water treatment equipment according to the exemplary embodiment of the present disclosure can discharge contaminants such as sludge stripped from the tubular filter part 20 and washing water to the outside of the filtration tank by using the discharge pipe part 30 (see FIG. 5(a)). Preferentially, to implement a backwash function, the water treatment equipment of the present disclosure discharges treated water filtered through the tubular filter part 20 and the one or more fine mesh filter parts to the outside of the filtration tank F, and then discharges water filled in the duct 33 to the outside by opening the valve V₃ (see FIG. 1). Accordingly, as a water level inside the buoyancy tube 31 is lowered, the buoyancy ball 32 moves downward, and as a result, the hinged cover 132 can be opened. The tubular filter part is backwashed by the operation of the filter washing part 50, wherein washing water is sprayed to remove sludge attached to the tubular filter part 20. As described above, contaminants such as sludge stripped from the fibrous filter media of the tubular filter part and washing water can be discharged through the opened hinged cover 132, the buoyancy tube 31, and the duct 33 to the outside.

Unlike this, in another process other than backwashing, for example, during filtration, the valve V₃ is closed and contaminated water flowing into the inflow pipe 12 is filtered through a process of flowing in a radial direction through the tubular filter part from the inner hollow area of the tubular filter part. As the level of water inside the buoyancy tube 31 rises while treated water inside the tubular filter part is filled in the inside of the discharge pipe part, that is, the duct 33 and the buoyancy tube 31 through the opened hinged cover, the buoyancy ball 32 moves upward and as a result, the hinged cover 132 is rotated upward to close the discharge hole 131, and contaminated water is confined in a radial direction, thereby providing an effective filtration function.

In other words, the water treatment equipment according to the exemplary embodiment of the present disclosure can effectively discharge sludge stripped from the fibrous filter media and washing water to the outside of the system without a separate power source during backwashing.

Above, the present disclosure has been explained in detail through the embodiment, but this is to specifically explain the present disclosure, and the water treatment equipment according to the present disclosure is not limited thereto, and it will be clear that modifications or improvements are possible by those skilled in the art within the technical idea of the present disclosure.

All simple modifications or changes to the present disclosure fall within the scope of the present disclosure, and the specific scope of protection of the present disclosure will be clarified by the attached patent claims.

The invention claimed is:

1. Water treatment equipment comprising:
a guide part (10) having a conical body (11) open up and down, an inflow pipe (12) extending downward from the conical body (11) to guide contaminated water into a filtration tank (F), and an annular support surface (13) having multiple discharge holes (131) disposed to be spaced apart in a circumferential direction from each other and a hinged cover (132) configured to open and close each of the discharge holes (131), with the annular support surface (13) being disposed along an upper edge of the conical body (11);
a tubular filter part (20) having a fixed frame (21) configured to dispose multiple compartments (21a) divided along an inner circumferential edge of the annular support surface (13) and a curtain filtration layer (22) inserted into each of the compartments (21a), with the tubular filter part (20) installed in a tubular shape on the annular support surface;
a discharge pipe part (30) having multiple buoyancy tubes (31) disposed respectively under the discharge holes (131) of the annular support surface (13) to enable fluid communication therebetween, and a duct (33) being in fluid communication with the multiple buoyancy tubes (31) and extending to the outside of the filtration tank (F); and
a filter washing part (50) configured to spray washing water for backwashing on the tubular filter part (20),
wherein the tubular filter part (20) allows contaminated water guided into the guide part (10) to pass through the tubular filter part (20) in a radial direction for filtration, and during backwashing, contaminants stripped from filter media of the tubular filter part and washing water are discharged through the discharge pipe part (30) to the outside of the filtration tank.

2. The water treatment equipment of claim 1, wherein the discharge hole (131) is located in an inner area of the compartment (21a).

3. The water treatment equipment of claim 1, wherein the discharge pipe part (30) comprises:
the multiple buoyancy tubes (31) having upper through-holes and lower through-holes;
a buoyancy ball (32) configured to open and close the hinged cover (132) by moving up and down according to a water level inside each of the buoyancy tubes (31); and
the duct (33) disposed to be in fluid communication with lower parts of the multiple buoyancy tubes (31), with the duct (33) having a valve (V₃) provided on an end part of a pipe thereof.

4. The water treatment equipment of claim 1, wherein the inflow pipe (12) comprises a branch pipe (15) extending to the outside of the filtration tank (F) by branching off from the inflow pipe, and a valve (V₁) provided on an end part of the branch pipe (15).

5. The water treatment equipment of claim 1, wherein the guide part (10) comprises one or more fine mesh filter parts (40; 41, 42) having concentric structures with the tubular filter part (20) and disposed on the annular support surface (13).

6. The water treatment equipment of claim 1, wherein the fixed frame (21) defines the multiple compartments (21a) through a perforated screen (211) having a tubular shape disposed on an inner circumferential edge of the annular support surface (13) along a circumference thereof, a tubular fixed mesh (212) disposed outside the perforated screen (211) on the annular support surface, with the tubular fixed mesh (212) being concentric with the perforated screen (211) and having an increased diameter, and multiple partition walls (213) disposed to be spaced apart from each other in a circumferential direction between the perforated screen (211) having a tubular shape and the tubular fixed mesh (212).

7. The water treatment equipment of claim 1, wherein the curtain filtration layer (22) is provided with one or more fibrous filter media (221).

8. The water treatment equipment of claim 5, wherein the curtain filtration layer (22) and the one or more fine mesh filter parts (40; 41, 42) are formed and arranged to be denser gradually in a radial direction.
